(19) United States
(12) Patent Application Publication
(10) Pub. No.: US 2008/0071590 A1
(43) Pub. Date: Mar. 20, 2008

(54) Solving a model to select members of a portfolio

(76) Inventors: Bin Zhang, Fremont, CA (US); Dirk M. Beyer, Walnut Creek, CA (US); Shailendra Jain, Cupertino, CA (US); Jing Zhou, Charlotte, NC (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/521,621

(22) Filed: Sep. 15, 2006

(51) Int. Cl. G06F 9/44

(52) U.S. Cl. 705/7

(57) ABSTRACT

A computer-executable method provides plural constraints representing corresponding objectives of an enterprise, where the objectives are related to members of the enterprise's portfolio. A model is provided for selecting the members of the portfolio, where the model contains the plural constraints. The model is solved to select the members of the portfolio.

### BACKGROUND

In the business world, many companies offer products or services to consumers in order to produce revenue. However, these companies often compete against other companies for a finite number of customers. In order to gain a competitive advantage, some companies offer a broad variety of products (or services) in an attempt to increase their market share. While such variety has the potential to attract more customers, this proliferation of products can also lead to various issues.

For example, as a company offers an increasing number of products, customers can become increasingly overwhelmed and frustrated by the difficulty of choosing from a large selection. Similarly, salespeople can find it difficult to make recommendations to customers from among the large array of choices. Further, product proliferation generally contributes to increased actual expenses for a corporation. Such expenses include the costs associated with additional time and labor, shipping costs, and the cost of the inventory itself, both in terms of capital costs and the risk of obsolescence.

An order submitted by a customer often includes multiple products. Product proliferation can complicate fulfillment of such orders. If one product in an order is unavailable, the delivery of the order could be delayed until that product is replenished. When a company offers a large number of products, it is typically difficult and costly to maintain high availability for all products in its offering. As a result, poor availability of even one product can cause delays in delivery of numerous orders, which, in turn, could adversely affect customer satisfaction and revenue.

The range of products offered by a company is referred to as a product portfolio. Conventionally, many companies select a product portfolio by simply choosing the products that generate the most revenue. However, this approach can result in lost sales when customers switch to other companies because a particular company has dropped a popular (but low-revenue) product.

### BRIEF DESCRIPTION OF THE DRAWINGS

Some embodiments of the invention are described with respect to the following figures:

FIG. 1 is a block diagram of a computer that includes a coverage analysis tool, in accordance with an embodiment;

FIG. 2 is a flow diagram of a process performed by the coverage analysis tool, according to an embodiment; and

FIG. 3 is a flow diagram of a process of solving a maximum flow problem that is part of the process of FIG. 2, in accordance with an embodiment.

### DETAILED DESCRIPTION

In accordance with some embodiments, a coverage analysis tool is provided to enable the identification of members of a portfolio (for a particular enterprise) that satisfy multiple constraints, where the constraints correspond to objectives of an enterprise. A portfolio refers to a group of offerings by a particular enterprise, where the enterprise can be a business, an educational organization, a government agency, or some other type of entity or person. The offerings of the enterprise include products, services, or any other item that can be provided by the enterprise to consumers. The members of the portfolio include the products, services, and/or any other item that can be provided by the enterprise to consumers. A “constraint” refers to any criterion that is to be satisfied when selecting members of the portfolio. The constraints that are to be satisfied refer to objectives of the enterprise (e.g., business objectives of a company, educational objectives of an educational organization, etc.). For example, in the context of selecting a portfolio of products that are offered by a business, the business objectives may include revenue and profit margin. In such an example, the coverage analysis tool according to some embodiments identifies the smallest portfolio of products that satisfies a revenue target and a profit margin target.

The portfolio selection problem (for selecting members of a portfolio) is represented as a model that includes the objectives of the enterprise. In general, according to an embodiment, the coverage analysis tool converts the model representing the portfolio selection problem into a maximum flow problem, where the maximum flow problem is solved by the coverage analysis tool to identify a potential solution. A maximum flow problem refers to a problem of identifying a maximum flow from a source vertex to a target vertex in a network of vertices. As explained in detail further below, the intermediate vertices in the network (between the source and target vertices) represent members of the portfolio and orders for the members of the portfolio. The intermediate vertices include a first set of vertices that represent candidates for the members of the portfolio, and a second set of vertices that represent the orders. In some embodiments, the network is a bipartite network. A maximum flow is a flow of maximum value from the source vertex to the target vertex through the intermediate vertices, where flow refers to flow of quantities between vertices.

Once potential solutions are identified in response to identifying corresponding maximum flows in the network for different parameter values (discussed further below), a search is performed with respect to the potential solutions to identify the optimal solution. In the example given above with respect to selection of products within a portfolio, the identified solution includes the smallest portfolio of products that satisfy revenue and margin objectives.

Although reference is made to selecting products of a portfolio that satisfy revenue and margin objectives in the ensuing discussion, it is noted that techniques according to some embodiments can be applied to selection of other types of members in other portfolios that satisfy other types of objectives. Also, although the ensuing discussion refers to two objectives (increasing revenue and increasing margin), it is noted that some embodiments of the invention can be applied to solving problems having more than two objectives. Examples of other objectives of enterprises may include reducing costs, increasing market share (note that increasing market share may be the side effect of the optimization but not directly set as the goal of the optimization), increasing student enrollment, increasing customer satisfaction, increasing average technical support response time, increasing average speed at which servers (e.g., web servers) respond to on-line requests, reducing complaints, reducing returns of products, increasing product availability, reducing hold times of a call center, and so forth.

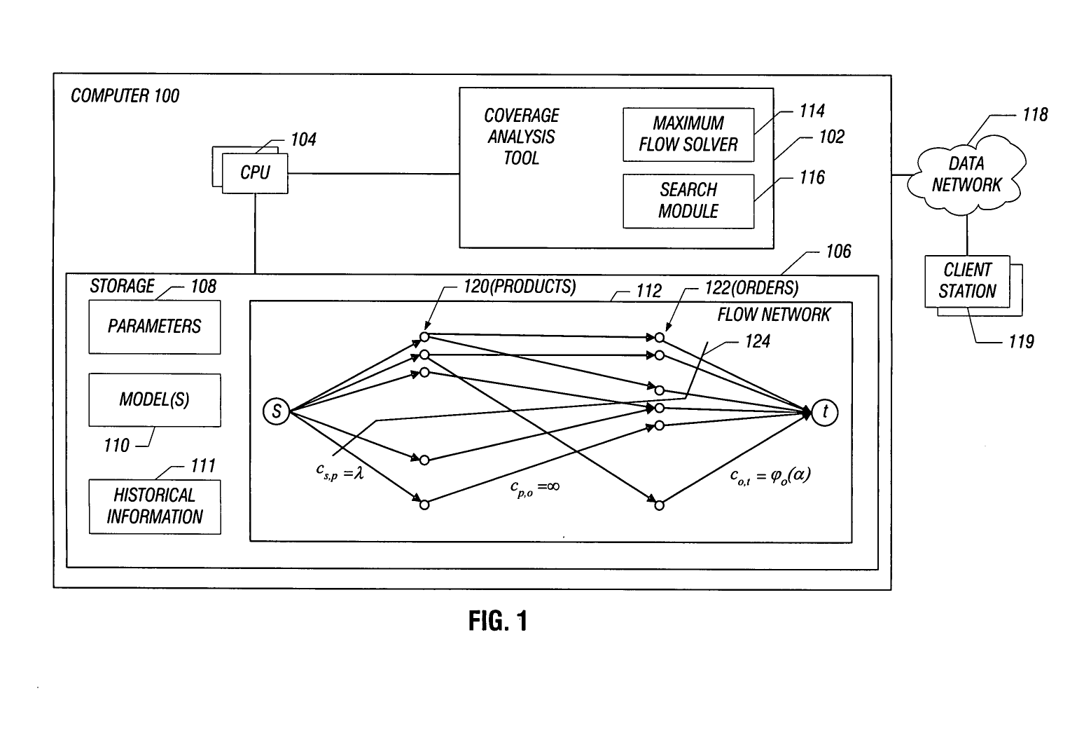

FIG. 1 illustrates a computer 100 that has a coverage analysis tool 102 executable on one or more central processing units (CPUs) 104. The term “tool” refers to one or more software modules in the computer 100 that are executable in the computer 100. In a different embodiment, the coverage analysis tool 102 can also refer to a tool that is at least partially implemented with hardware.

The CPU(s) 104 is (are) connected to a storage 106 in the computer 100, where the storage 106 can be implemented with one or more storage devices, including volatile storage devices (e.g., dynamic random access memories or static random access memories) and persistent storage devices (e.g., disk-based storage devices). The storage 106 is used for storing various types of information, including parameters 108 associated with the problem that is to be solved by the coverage analysis tool 102, and one or more models 110 representing the problem that is to be solved. Note that the parameters 108 are provided as part of the model(s) 110. The parameters 108 are used to define constraints associated with the model(s) 110. The computer (or a system that includes the computer) may also include a database system for selecting and formatting input data (such as input data relating to the parameters 108) and managing the outputs from the model(s) 110. The computer (or a system that includes the computer) may also include a user interface to allow users to interactively influence the selection of input data.

Also, in accordance with some embodiments, a model 110 is converted into a flow network 112 (e.g., a bipartite network) to represent the portfolio selection problem to be solved, where the coverage analysis tool 102 is used to identify a maximum flow in the flow network 112 for the purpose of identifying a solution for the portfolio selection problem represented by the flow network 112. Details of the flow network 112 are discussed further below.

The coverage analysis tool 102 according to some embodiments includes a maximum flow solver 114 (for identifying a maximum flow in the flow network 112). Also, a search module 116 is provided in the coverage analysis tool 102 for searching among various solutions that have been identified by the maximum flow solver 114 as possible solutions, such that an optimal solution can be identified.

The computer 100 is coupled over a data network 118 to one or more client stations 119. The data network 118 allows a user at a client station 119 to access the computer 100 to invoke the coverage analysis tool 102 for the purpose of solving a target problem, such as identifying products of a portfolio that satisfy revenue and margin objectives.

The portfolio selection problem takes into account historical information (stored as 111 in the storage 106) relating to prior transactions (such as purchase orders) that have been received by a particular enterprise. The historical information 111 includes information regarding past orders and past products maintained by an enterprise, where the information can include revenue and margin information on a per order basis. The historical information 111 is maintained for some past time period (e.g., a predefined number of weeks, months, quarters, years, etc.). From the historical information 111, parameters 108 can be identified to be provided to a model 110 that is to be processed by the coverage analysis tool 102. An example model, and associated parameters, for a product portfolio selection problem are discussed below.

Let P={p} be a set of products and O={o} a set of orders (e.g., purchase orders submitted by consumers at an on-line website). The sets P and O are derived from the historical information 111. Each order o contains a number (one or more) of products. Let rₒ be the revenue for order o (also derived from the historical information 111). If a single objective to be satisfied is the revenue objective, then the problem can be expressed as choosing a subset of products as the portfolio of product offerings so that the revenue from the portfolio of offerings is maximized among all choices of portfolios of the same size. (Note, however, that embodiments of the invention are used to address multiple objectives in selecting the product portfolio, as discussed further below). The following is assumed: an order can be shipped if and only if all the products in the order are in the portfolio of product offerings.

For each product p, an indicator variable xₚε{0,1} is defined, where xₚ=1 if p is in the portfolio of product offerings; otherwise xₚ=0 (which means product P is not in the portfolio). Another indicator variable, yₒε{0,1}, is also defined, where yₒ=1 if order o is covered by the portfolio of product offerings, which means that all the products in order o are in the portfolio. The indicator variable yₒ=0 if the order is not covered by the portfolio, which means that at least one of the products is not in the portfolio of product offerings.

A single-objective (revenue objective) portfolio selection problem maximizes the covered revenue for a given portfolio size S (the portfolio should have no more than S number of products). This portfolio selection problem is modeled as an integer programming problem, as follows:

$$max {\sum }_{o} {r}_{o} {y}_{o} \\ s . t . {y}_{o} \leq {x}_{p} , when p ∈ o \\ {y}_{o} , {x}_{p} ∈ \{ 0 , 1 \} \\ {\sum }_{p} {x}_{p} < S \qquad ( Eq . 1 )$$

This model has a single well-defined objective of maximizing the revenue of the products shipped. The maximization is done under a number of criteria: the first criterion (yₒ≦xₚ) specifies that yₒ can be 1 only if all the products in the order are in the portfolio; the second criterion (yₒ,xₚε{0,1}) limits the values of the variables to be integers 0 or 1; and the third criterion

$$( {\sum }_{p} {x}_{p} < S )$$

is size of the portfolio, which has to be smaller or equal to a given size S.

However, Eq. 1 above allows only one objective to be specified (the revenue objective). If an enterprise wishes to perform portfolio selection also based on another objective, then Eq. 1 cannot easily be extended to cover such other objective. One example of considering multiple objectives in product portfolio selection is considering both the revenue and the margin of orders shipped. Considering multiple objectives in performing product portfolio selection is also referred to as hedging between or among the multiple objectives.

Revenue and margin represent different objectives of the business. Higher revenue sometimes may not imply a higher margin (profit); however, higher revenue usually reflects a higher market share. On the other hand, optimizing based on just the margin of the business may cause loss of revenue and market share. For example, a large market share in the PC (personal computer) business (which can have low margins) can lead to large market share in a printer business (which can have high margins). A portfolio selection that focuses just on margin can cause various unprofitable PC models to be dropped; however, reduced PC sales may hurt sales of printers, which can have the unintended consequence of reducing revenues in the high-margin printer business.

To allow multiple objectives of an enterprise to be considered in performing portfolio selection, the portfolio selection problem of Eq. 1 is converted to its (mathematical) dual form, which is the problem of minimizing the portfolio size under the constraint of covering a given amount of revenue:

$$min {\sum }_{p} {x}_{p} \\ s . t . {y}_{o} \leq {x}_{p} , when p ∈ o \\ {y}_{o} , {x}_{p} ∈ \{ 0 , 1 \} \\ {\sum }_{o} {r}_{o} {y}_{o} \geq R . \qquad ( Eq . 2 )$$

In Eq. 2 above, R represents a target total revenue that an enterprise wishes to achieve. The target total revenue R can be based on some percentage of the total revenue calculated based on historical orders for some prior time period. Whereas Eq. 1 states the portfolio selection problem as maximizing revenue while keeping the portfolio size less than a predefined size S, Eq. 2 restates the portfolio selection problem as minimizing the portfolio size while satisfying the constraint that the aggregated revenue from orders should be greater than a predefined target total revenue R. Note that Eq. 2 has redefined the revenue objective of Eq. 1 as a constraint in Eq. 2. The dual form of Eq. 2 allows for the integration of more objectives of the enterprise.

Eq. 3 below adds another objective of the enterprise, the margin objective.

$$min {\sum }_{p} {x}_{p} \\ s . t . {y}_{o} \leq {x}_{p} , when p ∈ o , {y}_{o} , {x}_{p} ∈ \{ 0 , 1 \} \\ {\sum }_{o} {r}_{o} , {y}_{o} \geq R \\ {\sum }_{o} {m}_{o} {y}_{o} \geq M \qquad ( Eq . 3 )$$

In Eq. 3, the margin objective,

$${\sum }_{o} {m}_{o} {y}_{o} \geq M ,$$

specifies that the sum of the margins of a set of orders that are covered by a portfolio (yₒ=1) is greater than a target total margin M. The target total margin M is a percentage of a sum of margins of historical orders that are part of the historical information 111. In Eq. 3 above, both the revenue objective,

$${\sum }_{o} {r}_{o} {y}_{o} \geq R ,$$

and the margin objective

$${\sum }_{o} {m}_{o} {y}_{o} \geq M ,$$

are specified as constraints for the problem of minimizing

$${\sum }_{p} {x}_{p}$$

(the number of products in the portfolio).

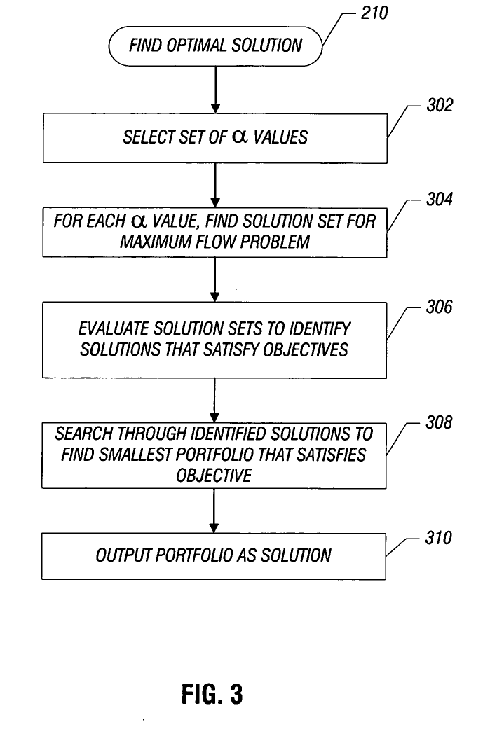

Although two objectives of the enterprise are added as constraints to the model of FIG. 3, it is noted that additional objectives of an enterprise can be added to the model in other implementations.

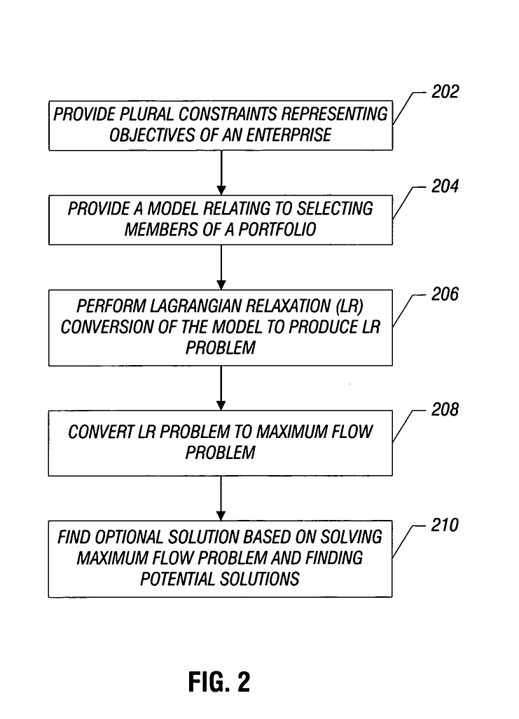

FIG. 2 shows a process performed by the coverage analysis tool 102 in accordance with some embodiments. Initially, plural constraints representing objectives of an enterprise are provided (at 202). The term “provide” can refer to storing the plural constraints, generating the plural constraints, receiving the plural constraints, and so forth. The plural constraints are based on the parameters 108, some of which are derived from historical information 111. Thus, in Eq. 3 above, the parameters 108 include yₒ, rₒ, mₒ, R, and M. Based on the parameters 108, the constraints can be calculated. The constraints can be manually calculated by a user and entered into the coverage analysis tool 102. Alternatively, the coverage analysis tool 102 can compute the constraints based on the parameters 108.

The coverage analysis tool 102 also provides (at 204) a model 110 (such as in the form of Eq. 3) that relates to selecting members of a portfolio. The model 110 also includes the constraints that are provided at 202.

The model of minimizing the portfolio size based on the constraints associated with plural objectives of the enterprise is converted (at 206) by the coverage analysis tool 102. In some embodiments, the conversion used is a Lagrangian Relaxation (LR) conversion, which produces the following LR problem (or LR model) for multiple objectives:

$$min \{ {\sum }_{p} {x}_{p} - γ ( {\sum }_{o} {r}_{o} {y}_{o} - R ) - μ ( {\sum }_{o} {m}_{o} {y}_{o} - M ) \} \\ s . t . {y}_{o} \leq {x}_{p} , when p ∈ o , 0 \leq {y}_{o} , {x}_{p} \leq 1 \qquad ( Eq . 4 )$$

In Eq. 4 above, the parameters γ and μ are Lagrangian coefficients that represent penalties when the constraints representing the objectives of the enterprise are violated. Lagrangian Relaxation allows for relaxation of variables to take continuous values. In Eq. 4 above, the variables yₒ, xₚ are allowed to take continuous values between 0 and 1, rather than be restricted to integer values 0 and 1 as specified in Eq. 3.

It is desirable to find solutions to the problem represented by Eq. 4 under different values of R and M, which can be considered as parameters of the model expressed by Eq. 4. The solutions under different values of R and M will provide the best choices of the portfolios under coverage of different total revenue and margin values. Since there are two parameters, one technique of solving the problem is to fix a first parameter while changing a second parameter to find solutions based on the changing second parameter. Although possible in some cases (particularly for smaller problems), solving the minimization problem of Eq. 4 in the manner noted above can take a relatively long time for any problem of non-trivial size (e.g., any problem involving hundreds to thousands of products or hundreds of thousands of orders).

In accordance with some embodiments, to make solving the minimization problem represented by Eq. 4 more efficient, the LR problem (or LR model) of Eq. 4 is converted to a maximum flow problem. Although some embodiments perform LR conversion as an intermediate step prior to conversion of the portfolio selection problem to a maximum flow problem, it is noted that the LR conversion step can be omitted in other embodiments, with a different technique used to convert the portfolio selection problem to a maximum flow problem. The conversion from the LR problem (Eq. 4) to a maximum flow problem includes the following:

$${\sum }_{p} {x}_{p} - γ {\sum }_{o} {r}_{o} {y}_{o} - μ {\sum }_{o} {m}_{o} {y}_{o} = {\sum }_{p} {x}_{p} - ( γ + μ ) * {\sum }_{o} \frac{γ {r}_{o} + μ {m}_{o}}{λ + μ} {y}_{o} = {\sum }_{p} {x}_{p} - δ * {\sum }_{o} [ α {r}_{o} + ( 1 - α ) {m}_{o} ] {y}_{o} , \\ where 0 < α = γ / ( γ + μ ) < 1 and δ = γ + μ . \qquad ( Eq . 5 )$$

In Eq. 5 above, the expression

$${\sum }_{p} {x}_{p} - γ {\sum }_{o} {r}_{o} {y}_{o} - μ {\sum }_{o} {m}_{o} {y}_{o}$$

is a rewritten form of the expression

$$\{ {\sum }_{p} {x}_{p} - γ ( {\sum }_{o} {r}_{o} {y}_{o} - R ) - μ ( {\sum }_{o} {m}_{o} {y}_{o} - M ) \}$$

in Eq. 4, with constant values R and M removed. Since Eq. 4 is a minimization problem, the constants R, M do not affect the minimization problem and thus can be omitted from the rewritten form in Eq. 5. For further technical convenience, Eq. 5 can be rewritten as follows:

$$λ {\sum }_{p} {x}_{p} - {\sum }_{o} [ α {r}_{o} + ( 1 - α ) {m}_{o} ] {y}_{o} , \qquad ( Eq . 6 )$$

where λ=1/δ.

Based on the above, the LR problem of Eq. 4 can be expressed as follows:

$$min \{ λ {\sum }_{p} {x}_{p} + {\sum }_{o} {ϕ}_{o} ( α ) ( 1 - {y}_{o} ) \} \\ s . t . {y}_{o} \leq {x}_{p} , when p ∈ o , 0 \leq {y}_{o} , {x}_{p} \leq 1. \\ where {ϕ}_{o} ( α ) = α {r}_{o} + ( 1 - α ) {m}_{o} . \qquad ( Eq . 7 )$$

In Eq. 7 above, the parameters λ and a are the parameters to be varied for finding potential solutions.

The new form of the LR problem as expressed in Eq. 7 allows a parameterized maximum flow problem to be derived, where the parameterized maximum flow problem is solved by finding a maximum flow in the flow network 112 in FIG. 1. In the flow network 112, the vertices on the left (referenced by numeral 120) represent products, while the vertices on the right (referenced by numeral 122) represent orders. More generally, the vertices 120 represent candidates for members of a portfolio, while the vertices 122 represent demand for subsets of the candidates. In addition, the flow network 112 also includes a source vertex s and a target vertex t. The vertices of the flow network 112 are connected by arcs (the arcs are directed links), where each arc is associated with a capacity c. In other words, the arcs connecting the vertices of the flow network 112 are capacitated. An arc of capacity c allows a flow between vertices connecting the arc up to the capacity c. The arcs between the product vertices 120 and the order vertices 122 are defined as having infinite capacity (in other words, c_{p,o}=∞, which represents the order-to-product dependencies). The capacities of each of the arcs from the source vertex to the product vertices 120 are equal to the parameter value λ, as defined in Eq. 6 above. The capacity of each arc from order vertices 122 to the target vertex t is equal to φₒ(α)=αrₒ+(1−α)mₒ, as defined by Eq. 7 above. Note that φ(α) is a function of the parameter α. Normally, the revenue is greater than the margin on any order, so that the function φₒ(α)=αrₒ+(1−α)mₒ, is a monotone increasing function of α. Since arcs connecting the source vertex s to the product vertices 120 and arcs connecting the order vertices 122 to the target vertex t are associated with parameters, the flow network 112 is referred to as a parameterized flow network.

Given the flow network 112 that has been converted from the LR model, the coverage analysis tool 102 solves for maximum flows of the flow network for different values of λ and α to identify potential solutions. The maximum flows for different values of λ and α correspond to potential solutions. The potential solutions are searched by the search module 116 to find (at 210) the optimal solution regarding the members of the portfolio that satisfy the revenue and margin objectives of the enterprise.

The different values of λ, where λ=1/δ=1/(γ+μ), as expressed in Eqs. 5 and 6 above, correspond to different combinations of γ and μ values, which represent penalties associated with violations of the revenue and margin objectives, respectively. Parameter α(α=γ/(γ+μ)) represents the proportional mixture of the revenue and margin objectives. The closer the value of α is to 1, the more revenue objective influences portfolio selection. On the other hand, the closer the value of α is to 0, the more the margin objective influences the portfolio selection. Thus, as examples, if α is 0, then portfolio selection is based exclusively on the margin objective. If α is 1, then the portfolio selection is based exclusively on the revenue objective. If α=0.5, then portfolio selection is based on equal parts on the revenue and margin objectives.

In solving for the maximum flow of the network 112, various techniques can be used. In one embodiment, as discussed above, different values of α are fixed, and for each fixed value of α, the values of λ are varied. Thus, in this approach, the two-parameter problem (α and λ) is reduced to a single-parameter problem (λ), since α is fixed.

To solve the single-parameter maximum flow problem, the following technique can be used, according to one example implementation. First, a modified flow network is derived from the flow network 112 of FIG. 1, where the modification involves the replacement of the capacities of λ between the source vertex s and the product vertices 120 with infinite capacities. In other words, each arc between the source vertex s and the product vertices 120 in the modified flow network will have infinite capacity.

The flow in the network 112 can be initialized to some value through the arcs in the network 112. Specifically, the flow is pushed from the source vertex s to the target vertex t through every arc in such a way that all arcs from the order vertices 122 to the target vertex t become full. Then, the flow is redistributed among the arcs extending between the source vertex s and the product vertices 120, and between the product vertices 120 and order vertices 122. In one embodiment, the redistribution iteratively identifies a pair of arcs that have unequal flow and then pushing flows to make their flows as close as possible without causing negative flows on the arcs. The redistribution continues until no further pairs of unequal flows can be found, or until some stopping rule is encountered. The procedure above is also referred to as arc balancing or vertex balancing. At this point, the maximum flow in the modified flow network has been identified. For a given value of λ, the products excluded from the portfolio are the products associated with vertices 120 that have flow from the source vertex s that is less than the value of λ. The potential solution (products in the portfolio) for the given value of λ can thus be easily ascertained.

Note that the product vertices 120 may have been sorted by flow from the source vertex s. In this way, identifying product vertices to exclude from the portfolio can be readily performed, since any product vertices with flows less than λ are excluded.

Various techniques for finding maximum flows in single-parameter flow networks are described in U.S. Ser. No. 11/048,301, entitled “System and Method for Selecting a Portfolio,” filed on Jan. 30, 2005 by Bin Zhang et al.; U.S. Ser. No. 11/340,081, entitled “Determining an Amount of Flow Through, or a Cut of, a Parameterized Network,” filed Jan. 25, 2006 by Bin Zhang et al.; and U.S. Ser. No. 11/159,454, entitled “Determination of a State of Flow Through or a Cut of a Parameterized Network,” filed Jun. 22, 2005, by Bin Zhang et al.

FIG. 3 shows the tasks involved in finding the optimal solution (at 210) in greater detail. Initially, the set of α values are selected (at 302). Note that more accurate results can be obtained by selecting a higher number of α values. However, selecting a large number of α values also causes processing time in finding maximum flows to increase. Therefore, the actual set of α values selected is based on a compromise between accuracy and speed. Many variations on the selection of the values of α are possible. For example, the selection of the next α value could be related to the maximum flow solutions at the previously selected α values. Such smart selections become possible when additional knowledge on how α may influence the solution is available.

For each fixed α value, a solution set is identified for the maximum flow problem (at 304), where a solution set includes multiple solutions for corresponding maximum flows found for different λ values. Given a particular α value, the values of λ are increased such that the maximum flow in the network 112 also changes. Note that each maximum flow corresponds to a respective potential solution. In accordance with some embodiments, however, instead of using all maximum flows for all values of λ that have been processed, a subset (less than all) of the computed maximum flows is used. The maximum flows of interest are the maximum flows at the λ values where the minimum cut of the flow network 112 makes a “jump.”

A “cut” is a partition of the vertex set (set of vertices in the flow network 112) into two parts, one containing source vertex s and the other containing target vertex t. An arc (v, w) with v but not w in S “crosses” the cut S. The capacity of a cut S is Σ{c(v, w)|(v, w) is an arc crossing S}; in which c(v, w) represents the capacity of an arc (v, w). A cut is minimum if it has minimum capacity.

In FIG. 1, an example minimum cut 124 is depicted, where the minimum cut 124 divides the flow network 112 into two parts: vertices in the side of the flow network 112 containing the source vertex s, and vertices in the side of the flow network 112 containing the target vertex t.

As the value of λ increases, the minimum cut 124 tends to stay stable until the value of λ reaches a value that causes the cut 124 to move to provide a different division of the flow network 112. The values of λ that cause such jumps in the minimum cut 124 represent the discrete points of λ at which the minimum cut 124 changes. The maximum flows of interest are the maximum flows for the λ values at such discrete points.

The maximum flows calculated at the discrete points of λ mentioned above represent coverage of different target revenues and margins. The different maximum flows, and the associated values of λ and α, correspond to different potential solutions. The coverage analysis tool 102 next invokes the search module 116 to evaluate (at 306) the solution sets represented by the different maximum flows for different values of λ, α. The coverage analysis tool 102 identifies solutions that satisfy the objectives of the enterprise, while discarding the remaining solution sets.

Note that each solution specifies the products to be included in the portfolio. Since the products for each solution are known, the covered orders are also known. By simply summing the revenue and margin of the covered orders, the coverage analysis tool 102 can determine whether the given R and M values are satisfied (according to constraints

$${\sum }_{o} {r}_{o} {y}_{o} \geq R and {\sum }_{o} {m}_{o} {y}_{o} \geq M$$

identified in Eq. 3 above). If either of these two constraints is not satisfied, then the potential solution is discarded.

The coverage analysis tool 102 then invokes the search module 116 to search (at 308) through the identified solutions (that satisfy the plural objectives) to find the smallest portfolio that satisfies the plural objectives. In some implementations, the search is an automated search performed by the search module 116. Alternatively, the search can be manually performed by a user.

If performed automatically, the search module 116 can use a global optimization search algorithm to find the optimal solution in which the multiple objectives are satisfied. Examples of global optimization search algorithms include binary search, Golden Section search, and so forth. Using a global optimization search algorithm allows the optimal solution to be identified more quickly.

Note also that in searching through the various identified solutions, not all of the solutions have to be considered in view of the fact that φ(α) is a monotone increasing function of α. Thus, for a given value of α, the search module 116 can simply start with the smallest portfolio and successively look at solutions with larger portfolios until a portfolio that satisfies the business objective constraints has been identified. Once such a portfolio has been identified, larger portfolios do not have to be evaluated. Then, for the next value of α, the search module 116 knows that the solution should be close to the portfolio size identified for the prior value of α. As a result, the search module 116 can begin the search with a solution that has a portfolio size similar to the previously identified portfolio size. This process is iteratively repeated until the portfolio with the smallest size has been found that satisfies the business objective constraints.

The smallest portfolio found at 308 is then output (at 310) as the solution. The output solution can be locally displayed, incorporated into a report, or sent to a remote client station.

Instructions of software described above (including coverage analysis tool 102, maximum flow solver 114, and search module 116 of FIG. 1) are loaded for execution on a processor (such as one or more CPUs 104 in FIG. 1). The processor includes microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the software) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method executable in a computer, comprising:
providing plural constraints representing corresponding plural objectives of an enterprise, wherein the objectives are related to members of a portfolio provided by the enterprise;
providing a model relating to selecting the members of the portfolio, wherein the model contains the plural constraints; and
solving the model to select the members of the portfolio.

2. The method of claim 1, wherein providing the plural constraints comprises providing at least a first constraint representing a revenue related to the members of the portfolio, and a second constraint representing a profit margin of the members of the portfolio.

3. The method of claim 1, further comprising converting the model to a Lagrangian Relaxation (LR) problem, wherein solving the model comprises solving the LR problem.

4. The method of claim 3, further comprising converting the LR problem to a maximum flow problem, wherein solving the LR problem comprises solving the maximum flow problem.

5. The method of claim 1, further comprising generating a maximum flow problem according to the model, wherein solving the model comprises solving the maximum flow problem.

6. The method of claim 5, wherein the maximum flow problem is represented by a flow network having a source vertex, a target vertex, and intermediate vertices representing members of the portfolio and demand for the members of the portfolio,
wherein solving the maximum flow problem comprises identifying a maximum flow through arcs connecting the vertices.

7. The method of claim 6, further comprising defining capacities of the arcs in the flow network, wherein the capacities of the arcs between the source vertex and the intermediate vertices representing members of the portfolio are defined by a first parameter, and the capacities of the arcs between the intermediate vertices representing the demand and the target vertex are defined by a second parameter, the first and second parameters based on the plural objectives of the enterprise.

8. The method of claim 7, further comprising:
defining the first parameter based on values representing penalties associated with violating the corresponding objectives; and
defining the second parameter based on values representing proportional contribution of the plural objectives to selecting the members of the portfolio.

9. The method of claim 1, wherein the plural objectives comprise at least two of: increasing revenue, increasing margin, reducing cost, increasing market share, increasing student enrollment, increasing customer satisfaction, increasing average technical support response time, increasing average speed at which servers respond to on-line requests, reducing complaints, reducing returns of products, increasing product availability, and reducing hold times of a call center.

10. A method executable in a computer, comprising:
defining a problem relating to selecting members of a portfolio, wherein the selecting is according to plural objectives of an enterprise; and
solving the problem as a maximum flow problem to find a solution relating to selecting the members of the portfolio.

11. The method of claim 10, wherein the maximum flow problem is a parameterized maximum flow problem associated with plural parameters that define capacities in a flow network associated with the maximum flow problem, the method further comprising defining the plural parameters according to the plural objectives.

12. The method of claim 10, wherein solving the maximum flow problem to find the solution comprises finding a smallest portfolio that satisfies the plural objectives.

13. The method of claim 10, wherein the maximum flow problem is represented by a flow network having vertices and arcs connecting the vertices, the method further comprising:
defining at least two parameters to represent capacities of the arcs, wherein the at least two parameters are related to plural objectives of the enterprise;
varying values of the at least two parameters to find plural corresponding maximum flows that represent plural corresponding potential solutions,
wherein finding the solution comprises selecting one of the potential solutions.

14. The method of claim 13, wherein selecting one of the potential solutions comprises:
identifying at least a subset of the potential solutions that satisfy the plural objectives; and
from among the identified potential solutions, selecting the one solution that relates to a smallest size of the portfolio.

15. Instructions on a computer-usable medium that when executed cause a computer to:
provide plural constraints representing corresponding plural objectives of an enterprise, wherein the objectives are related to members of a portfolio provided by the enterprise;
provide a model relating to selecting the members of the portfolio, wherein the model contains the plural constraints; and
solve the model to select the members of the portfolio.

16. The article of claim 15, wherein the instructions when executed cause the computer to further convert the model to a Lagrangian Relaxation (LR) problem, wherein solving the model comprises solving the LR problem.

17. The article of claim 15, wherein the instructions when executed cause the computer to further generate a maximum flow problem according to the model, wherein solving the model comprises solving the maximum flow problem.

18. The article of claim 17, wherein the maximum flow problem is represented by a flow network having a source vertex, a target vertex, and intermediate vertices representing members of the portfolio and orders for the members of the portfolio,
wherein solving the maximum flow problem comprises identifying a maximum flow through arcs connecting the vertices.

19. The article of claim 18, wherein the instructions when executed cause the computer to further define capacities of arcs in the flow network, wherein the capacities between the source vertex and the intermediate vertices representing members of the portfolio are defined by a first parameter, and the capacities between the intermediate vertices representing the orders and the target vertex are defined by a second parameter, the first and second parameters based on the plural objectives of the enterprise.

20. The article of claim 15, wherein the plural objectives comprise at least two of: increasing revenue, increasing margin, reducing cost, increasing market share, increasing student enrollment, increasing customer satisfaction, increasing average technical support response time, increasing average speed at which servers respond to on-line requests, reducing complaints, reducing returns of products, increasing product availability, and reducing hold times of a call center.
